(19) United States
(12) Patent Application Publication
(10) Pub. No.: US 2002/0158084 A1
(43) Pub. Date: Oct. 31, 2002

(54) Pump assembly

(76) Inventors: William Peter Herring, Somerset (GB); Simon John Lapham, Somerset (GB); James Moore, Somerset (GB)

Correspondence Address: LARSON & TAYLOR, PLC, 1199 NORTH FAIRFAX STREET, SUITE 900, ALEXANDRIA, VA, 22314, US

(21) Appl. No.: 10/131,490

(22) Filed: Apr. 25, 2002

(30) Foreign Application Priority Data
Apr. 27, 2001 (GB) 0110429.8

(51) Int. Cl. B67D 5/06

(52) U.S. Cl. 222/321.7; 222/180

(57) ABSTRACT

A dispenser has a pump assembly with a housing (16) containing a pump (18,19) reciprocatably driven by a pump head (12) to pump liquid from the inlet to the outlet (45) of the pump. A spout (28) extends from the housing (16) and has a dispenser outlet (26). Due to the reciprocation of the pump (18,19) the pump outlet (45) moves relative to the dispenser outlet and to permit such movement they are interconnected by a flexible tube (24). The dispenser may also have a container for containing the liquid to be dispensed.

### BACKGROUND OF THE INVENTION

1. Field of the Invention

The present invention relates to a pump assembly. More particularly, the present invention relates to a pump assembly for a pump action liquid dispenser.

Pump action dispensers are used for dispensing liquid soap, for example. Such dispensers may of course be used to dispense other liquids, such as shampoos, conditioners, other toiletry products and non-toiletry products.

2. Summary of the Prior Art

Some dispensers are known which are adapted to be mounted at a surface (the surface typically referred to as a “deck”). Such deck-mounted dispensers have a dispenser outlet (from which the liquid is dispensed to a user) and a pump head. Both the dispenser outlet and the pump head are located above the surface. The pump head is pressable by a user in order to pump liquid from a reservoir of liquid to the dispenser outlet. The pump head and the dispenser outlet are the features of the dispenser which are used by a user. Typically, these features may incorporate an aesthetically pleasing design.

In general, deck-mounted dispensers fall into two categories. In a first category, deck-mounted dispensers tend to have dispenser outlets which are at a fixed height above the surface. In use, the pump head moves downwards relative to the dispenser outlet when the pump head is pressed by a user. In a second category, the pump head is at a fixed height with respect to the dispenser outlet. Therefore the dispenser outlet moves downwards relative to the surface when the pump head is pressed.

In the case where the dispenser dispenses soap onto a user's hand, for example, the movement of the dispenser outlet relative to the surface means that a user must move his/her hand in order to keep the dispenser outlet the same distance from his/her hand. This can be inconvenient, and means the distance which the dispenser outlet (and therefore the pump head) is moveable must be limited to a range over which it is reasonable to expect a user's hand to move. In turn, this can limit the volume of soap which is dispensed with each movement of the pump head.

Pump action liquid dispensers usually include a container which is attached to a pump assembly. The container may be directly attached to the pump assembly. Alternatively, the container may be remote from the pump assembly, liquid being communicable from the container to the pump assembly via a tube. The container holds the reservoir of liquid to be dispensed. The container is usually mounted or located underneath the surface at which the dispenser is mounted in order to keep the container out of view. However, for containers in the first category, this can lead to problems when it is necessary to refill the container. The construction of the pump assembly of many of the known dispensers in which the outlet is of fixed height is such that the container must be removed from the surface and then refilled. This means that it is necessary to reach under the surface in order to carry out the refilling operation. This can be time consuming and difficult.

Alternatively, the pump assembly of known dispensers in which the outlet is of fixed height is of complex construction in order that the container can be filled from above, i.e. without the need to remove the container from a surface below which it is located. Typically, such a refilling operation requires that a pump of complex construction is removed from the pump assembly before the refilling of the container.

To address the refilling problems, dispensers in the second category are often used, these being of simpler construction. However, this means that the dispenser outlet will not be fixed, contrary to what is desirable.

In the second category of pump action dispensers (in which the dispenser outlet is fixed with respect to the pump head) the pump head and the dispenser outlet may be integral, for example both may be parts of a spout. In such an arrangement, the pump assembly includes a pump, the pump head and integral dispenser outlet. The entire pump assembly may be removed from the surface. This leaves the container free to be filled from above, i.e. without the need to remove the container from a surface below which it is located.

The ease of removal of the pump assembly from the surface depends to some extent on the location of the dispenser outlet, which in turn depends on the pump. In this second category of dispensers, the dispenser outlet is removable from the surface along with the rest of the pump assembly since it is integral with (or rigidly attached to) the pump head.

Dispensers in the second category typically have a pump of simple construction which is easily and cheaply fabricated, for example a cartridge-type pump. A simple cartridge-type pump typically includes a pump chamber which is placed in communication with a reservoir of liquid in an attached container. In use, the dispenser is held in an upright position, the container being located below the pump assembly. Within the pump chamber, a piston is moveable to alter the volume of the pump chamber. The piston has a piston duct extending upwards from a lower piston face to a pump outlet. The pump chamber has a one-way valve (a pump chamber valve) at its lower end which allows liquid from the container to flow substantially only into the pump chamber. Another one-way valve (a piston valve) is located in the piston duct, for example at the lower piston face. The piston valve allows liquid to flow in a direction substantially only out of the pump chamber.

In the pump assembly, the piston is moveable downwards from a rest position by pressing the pump head. Subsequently, the piston is urged back to its rest position by spring means. Movement of the piston downwards reduces the volume of the pump chamber and therefore forces liquid out of the pump chamber. Due to the presence of the pump chamber valve, liquid is forced out through the piston duct. The liquid forced out is communicated from the pump outlet to the dispenser outlet via another duct. Alternatively, the piston duct may communicate directly with the dispenser outlet.

Movement of the piston back to its rest position draws liquid upwards into the pump chamber from the container. Liquid in the piston duct is substantially not drawn back into the pump chamber due to the presence of the piston valve.

### SUMMARY OF THE INVENTION

Accordingly, the present invention seeks to provide a dispenser in which the outlet is fixed with respect to a surface at which the dispenser is mounted, but with a simpler construction than dispensers in the first category.

At its most general, the present invention provides a flexible tube between a pump outlet and a dispenser outlet in a pump assembly, relative movement between the pump outlet and the dispenser outlet being accommodated by the flexible tube.

In a first aspect, the present invention may provide a pump assembly for a pump action liquid dispenser, the assembly having:

a pump comprising a pump chamber and a piston reciprocatable within the pump chamber so as to pump liquid between a pump inlet and a pump outlet, the pump being mounted in a housing;

a pump head reciprocatable relative to the housing so as to cause the piston to reciprocate relative to the pump chamber, the pump outlet moving with the pump head;

a dispenser outlet; and

a flexible tube connectable between the pump outlet and the dispenser outlet, relative movement between the pump outlet and the dispenser outlet being accommodated by the flexible tube.

Preferably, in use, the dispenser outlet is substantially fixed with respect to the housing. Alternatively, the dispenser outlet is rotatable with respect to the housing. This may allow, for example the dispenser outlet direction to be altered with respect to the housing.

Using the invention, a pump action liquid dispenser can be provided wherein the dispenser outlet is fixed with respect to the housing. In use, the housing may be fixed with respect to a surface. In that case, the dispenser outlet is also fixed with respect to the surface.

Preferably, a piston duct extends upwardly from a lower face of the piston to the pump outlet. A transfer duct may extend from the pump outlet to a transfer outlet. The flexible tube is preferably attachable to the transfer outlet.

The dispenser outlet may, for example, be an aperture in a spout. The spout may be fixed in relation the housing. Preferably, a portion of the spout is removable from the remainder of the spout in order to expose the flexible tube for removal. More preferably, the removable portion of the spout is located further from the housing than the remainder of the spout.

Preferably, the piston duct and/or the transfer duct and/or the flexible tube are formed from materials which are not substantially degradable and/or corrodible by the liquid to be dispensed. Preferably, such material are plastics materials. Previously, liquid passageways in dispensers have been made from metals which can corrode due to the specific liquids dispensed. This can lead to discolouration of the liquids and/or failure of the metallic passageways.

Preferably, the pump is a cartridge pump.

In a second aspect, the invention may provide a pump action liquid dispenser having a pump assembly according to the first aspect and a container for containing a reservoir of liquid to be dispensed.

The container may, in use, be attached to a surface. Alternatively, the container may be remotely connected to the pump assembly via a tube.

Preferably, the housing is rotatable with respect to the container in order to orientate the dispenser outlet to a desired position. In this case, if the dispenser is fixed to a surface, then it is the height of the dispenser outlet with respect to that surface which may be fixed. The container may, in use, be fixed to the surface. Preferably, the pump assembly is mountable at the surface via mounting means. Typically, the mounting means include a flange and compression means. The flange may include a flange collar aperture within which the pump assembly is locatable.

Preferably, the pump assembly is removable from the mounting means to allow the container to be refilled with liquid through an aperture is the mounting means (for example, the flange collar aperture) previously occupied by the pump assembly.

Preferably, the mounting means and/or pump assembly includes container attachment means. These may be one or more of snap-together means, locking means and screw-fit means.

### BRIEF DESCRIPTION OF THE DRAWINGS

A preferred embodiment of the invention will now be described, by way of example only, with respect to the accompanying drawings in which:

FIG. 1, which shows a schematic cross sectional view of a pump assembly and mounting means according to an embodiment of the present invention; and

FIG. 2 shows the pump assembly of FIG. 1 mounted on a surface.

### DETAILED DESCRIPTION

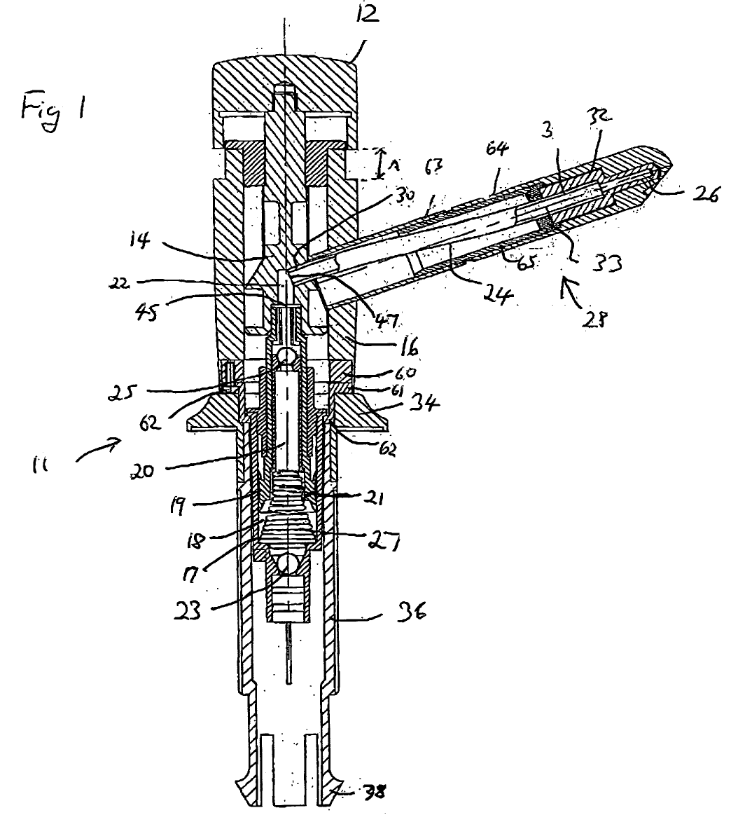

In FIG. 1, dispenser pump assembly 10 includes a pump head 12 attached to a shaft 14. Shaft 14 is located within cylindrical housing 16.

Pump head 12 is movable along the principal axis of housing 16. The typical distance of travel is marked “A” on FIG. 1. Movement of pump head 12 down along this axis, for example by a user, also forces shaft 14 downwards.

The pump assembly incorporates a cartridge pump. The cartridge pump includes a pump body 17 defining a pump chamber 18 within which piston 19 is operable to reciprocate. Piston 19 has an aperture 21 in its lower face. Furthermore, piston 19 is hollow, defining space 20. At its upper end, piston 19 is attached to shaft 14. Movement of pump head 12 moves both shaft 14 and piston 19. Movement of piston 19 downwards in FIG. 1 forces liquid (not shown) upwards from pump chamber 18 into space 20 via aperture 21.

As has already been explained above, a valve 23 (e.g. a ball valve) at the base of pump chamber 18 prevents liquid from pump chamber 18 from being expelled downwards when piston 19 moves downwards. Instead, the liquid is forced upwards into space 20 via aperture 21. In normal operation, space 20 is already filled with liquid from previous pumping actions. Consequently, the forcing in of more liquid into space 20 causes liquid to be forced out of the pump outlet. In this example, the pump outlet is piston outlet 45. However, it is to be understood that the pump outlet could be located elsewhere in the pump assembly. Piston outlet 45 is in liquid communication with a dispenser outlet 26 via a transfer duct 22 and a tube 24. Liquid forced out from space 20 will therefore subsequently be forced out of the dispenser at dispenser outlet 26.

The pump assembly includes a spring (27) which urges the piston towards a rest position at which the distance between the lower face of piston 19 and valve 23 is maximised in the assembly. When piston 19 returns to its rest position after being pressed downwards, liquid is drawn up into the pump chamber 18 through valve 23. Valve 23 is in a fixed location with respect to housing 16. Liquid in tube 24 is substantially not drawn into space 20 during this part of the stroke since ball valve 25 (at the top of space 20 in this example) will only allow liquid flow in the opposite direction. It will be readily apparent to the skilled person that valve 25 could be located, for example, at aperture 21, and still perform the same function.

As will be readily apparent from FIG. 1, movement of the pump head (and therefore the shaft 14 and piston 19) downwards in FIG. 1 causes similar movement of the piston outlet 45. Consequently, if the piston outlet 45 were rigidly connected to outlet 26, then it follows that outlet 26 would also be forced to move with the pump head, shaft and piston.

Transfer duct 22 is a channel formed in shaft 14 and is rigid. Similarly, transfer outlet 47 is rigid.

However, the transfer duct and the outlet are connected via tube 24 which is a flexible tube. In addition, outlet 26 is fixed with respect to housing 16. This is achieved using a rigid spout arrangement 28 which is rigidly attached to the housing 16 at one end and has the dispenser outlet 26 (an aperture in the spout) at its other end.

The internal dimensions of spout 28 in the region of the spout attached to the housing are sufficient to accommodate the travel of flexible tube 24 at this location. Of course, the amount of travel required depends to a large extent on the allowable amount of travel of shaft 14 which in turn depends on the allowable amount of travel of piston 19 in pump chamber 18.

One end 30 of flexible tube 24 is fixed to the transfer outlet 47 e.g. by adhesive and moves with the transfer outlet 47 relative to the housing 16 and the spout 28. The other end 31 of the flexible tube is fixed in a nozzle 32 e.g. by adhesive, and the nozzle 32 is held in the end of the spout arrangement 28 by a C-shaped washer 33. Accordingly, although the flexible tube may, in part, move with the transfer outlet 47 (and hence with the shaft 14), the spout 28 need not move when the pump is operated by a user. This has the advantage that the user need not move his/her hand (which typically collects liquid dispensed from the dispenser outlet 26), as discussed above.

In use, the dispenser arrangement 10 is associated with mounting means 11 and with a container (not shown in FIG. 1) containing liquid to be dispensed.

Mounting means 11 includes a flange 34 and a threaded cylindrical projecting portion 36. The mounting 11 is typically fixed to a mounting surface by passing projecting portion 36 through a hole in the surface so that flange 34 rests on the surface. A threaded nut (not shown) is then fitted on projection 36 and tightened against a lower surface of the mounting surface to retain the mounting means 11.

Shaped lugs 38 are provided in order to provide a snap fit with the container. In order to achieve this, the container has corresponding projections and recesses to accommodate shaped lugs 38. In certain embodiments, the mounting means may also provide a locking mechanism in order to lock the container to the mounting means.

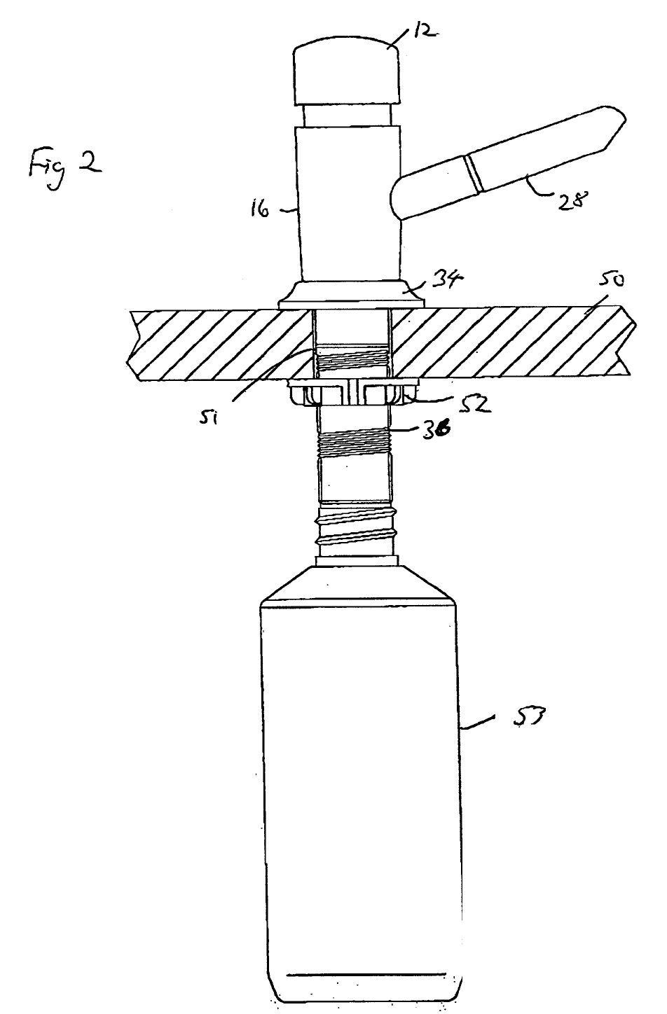

FIG. 2 shows the pump assembly of FIG. 1 mounted on a surface 50. As can be seen, the projecting portion 36 extends through a bore 51 in the surface 50, and a locking ring 52 on the projecting portion 36 is screwed upwardly on the projecting portion 36 until the surface 50 is held between the flange 34 and the locking ring 52. FIG. 2 also shows a container 53 secured to the lugs 38 to provide a reservoir of liquid. A tube (not shown) may extend from the lower end of the pump body 17 into the container 53.

Housing 16 is rotatable with respect to flange 34. In this way, housing 16 is also rotatable with respect to a container attached to the mounting means 11, and/or a surface to which mounting means 11 and an associated container is fixed. Since spout 28 is located on housing 16, spout 28 is also rotatable with respect to flange 34. Therefore, in use, dispenser outlet 26 may be swivelled in order to move it to a desired location with respect to flange 34. This means that the dispenser of this embodiment provides a dispenser outlet whose height with respect to a mounting surface is substantially fixed, but whose position with respect to that surface may be moved via rotation.

The dispenser of this embodiment provides a relatively easy way to replace the pump (a cartridge-type pump). As can be seen from FIG. 1, the housing 16 terminates in a ring 60, to which is secured a base ring 61. The base ring 61 has a press-fit into the flange 34, and has a projection 62 at its lower end which engages the pump body 17.

The press-fitting of the base ring 61 in the flange 34 permits the housing to rotate, as previously described. However, it also permits the pump assembly to be removed from the flange, and hence from the surface 50 in FIG. 2. If the base ring 61 is pulled out of the flange 34, the pump is lifted with it, due to the engagement of the projection 62 and the pump body 17, so that the pump assembly is lifted clear of the projecting portion 36. This enables the container 53 to be refilled.

If the base ring 61 is then released from the ring 60, e.g. by releasing screw 62, the pump can be separated from the shaft 14 and housing 16. This enables the pump to be replaced if necessary. Moreover, in the embodiment illustrated, it is possible to remove the shaft 14 from the housing. Since the flexible tube 24 is secured to the shaft 14, it must be released from the spout 28. To achieve this, the spout 28 has two separable parts 63, 64, the former being fixed to the housing 16 and the latter being removably mounted via an internal ring 65 to the former. If the part 64 of the spout 28 is removed from the ring 65, the washer 33 can be removed due to its C shape and then the nozzle 32 can slide inside the ring 65. Thus, when the shaft is removed from the housing 16, the nozzle 32 slides inside the ring 65, and the part 63 of the spout, and can itself be removed from the housing 16. Thus, the assembly can be completely disassembled.

The above embodiments have been described by way of example only. Modifications of the described embodiments, further embodiments and modifications thereof will be apparent to the person skilled in the art and as such are within the scope of the present invention.

What is claimed is:

1. A pump assembly for a pump action liquid dispenser, the assembly having:
a pump comprising a pump chamber and a piston reciprocatable within the pump chamber so as to pump liquid between a pump inlet and a pump outlet, the pump being mounted in a housing;
a pump head reciprocatable relative to the housing so as to cause the piston to reciprocate relative to the pump chamber, the pump outlet moving with the pump head;
a dispenser outlet; and
a flexible tube connectable between the pump outlet and the dispenser outlet, relative movement between the pump outlet and the dispenser outlet being accommodated by the flexible tube.

2. A pump assembly according to claim 1, wherein the dispenser outlet is fixed with respect to the housing.

3. A pump assembly according to claim 1, wherein a transfer duct extends from the pump outlet to a transfer outlet and the flexible tube is attachable to the transfer outlet.

4. A pump assembly according to claim 1, wherein the dispenser outlet is an aperture in a spout.

5. A pump assembly according to claim 4, wherein a portion of the spout is removable from the remainder of the spout.

6. A pump action liquid dispenser comprising:
a pump comprising a pump chamber and a piston reciprocatable within the pump chamber so as to pump liquid between a pump inlet and a pump outlet, the pump being mounted in a housing;
a pump head reciprocatable relative to the housing so as to cause the piston to reciprocate relative to the pump chamber, the pump outlet moving with the pump head;
a dispenser outlet;
a flexible tube connectable between the pump outlet and the dispenser outlet, relative movement between the pump outlet and the dispenser outlet being accommodated by the flexible tube; and
a container for containing a reservoir of liquid to be dispensed, the pump being in communication with the interior of the chamber to pump liquid therefrom.

7. A dispenser according to claim 6, wherein the housing is rotatable with respect to the container.

8. A dispenser according to claim 6, further including mounting means for mounting the dispenser at a surface.

9. A dispenser according to claim 8, wherein the pump assembly is removable from the mounting means.
